(19) United States
(12) Patent Application Publication
(10) Pub. No.: US 2025/0149192 A1
(43) Pub. Date: May 8, 2025

(54) PLASMA AND GAS BASED OPTICAL COMPONENTS TO CONTROL RADIATION DAMAGE

(71) Applicant: Lawrence Livermore National Security, LLC, Livermore, CA (US)

(72) Inventors: Robert Kirkwood, Belmont, CA (US); Scott C. Wilks, Mountain View, CA (US); Matthew Reid Edwards, Santa Monica, CA (US); Pierre A. Michel, Oakland, CA (US)

(21) Appl. No.: 18/837,490

(22) PCT Filed: Feb. 17, 2023
(86) PCT No.: PCT/US2023/062853

§ 371 Date: Aug. 9, 2024

Related U.S. Application Data
(60) Provisional application No. 63/311,545, filed on Feb. 18, 2022.

(51) Int. Cl. G21B 1/23

(52) U.S. Cl. CPC G21B 1/23

(57) ABSTRACT

Plasma and gas based optics may be used to direct light to a target that produces emission harmful to solid-state optics. In some cases, a shield having a hole, opening or separation for the light to pass may be employed to attenuate or block such harmful emission from the target thereby providing some protection for the solid-state optics. In some designs, the light incident on the target is not coaxial with light sources such as pump and/or seed sources providing beams incident on the plasma or gas based optics. In various designs, however, the plasma or gas based optic(s) is resistant to the emissions from the target.

### CROSS-REFERENCE TO RELATED APPLICATIONS

This application claims the benefit of priority to U.S. Provisional Application No. 63/311,545, titled “PLASMA BASED OPTICAL COMPONENTS TO CONTROL RADIATION DAMAGE IN LASER FUSION POWER APPLICATIONS,” filed Feb. 18, 2022. The entirety of each application referenced above is incorporated herein by reference. Additionally, any and all applications for which a foreign or domestic priority claim is identified in the Application Data Sheet as filed with the present application are hereby incorporated by reference under 37 CFR 1.57.

### FEDERALLY SPONSORED RESEARCH OR DEVELOPMENT

This invention was made with Government support under Contract No. DE-AC52-07NA27344 awarded by the United States Department of Energy. The Government has certain rights in the invention

### BACKGROUND OF THE INVENTION

### Field of the Invention

The present disclosure relates generally to plasma and gas optics, such as for example, plasma and gas optics used in fusion power applications.

### Description of the Related Art

The demands that inertial fusion experiments place on their drivers have made National Ignition Facility (NIF) the largest laser facility in the world, including the large final optics that direct each beam to the target. A future Inertial Fusion Energy (IFE) facility will likely need to provide more laser energy at a dramatically increased repetition rate, which can pose two challenges: the optical components of these driving lasers are to be either larger or more damage resistant to support higher energy and able to withstand many more shots before replacement. Since significant debris, x-ray, neutron, and backscatter fluxes from the target can be expected, protecting the final laser optics is a substantial challenge. Any effort to make a more compact laser for delivering IFE-relevant energies to the target may therefore encounter such issues.

### SUMMARY OF THE INVENTION

One potential approach to these challenges is the use of plasma optics: plasma-based analogues for standard optical components. Plasmas are fundamentally more resistant to optical damage and a plasma-based optic is generally orders of magnitude smaller than a solid-state equivalent that can handle the same energy or power. Plasma optics is a research area which has seen rapid progress in the past decade. Many new concepts have been invented and, in some cases, demonstrated in laboratory experiments, including plasma photonic crystals¹, waveplates and polarizers⁸⁻¹⁰, diffractive lenses⁵, frequency converters¹², fast and slow light in plasmas¹⁹, or plasma gratings which are used to tune the symmetry of ICF implosions on the NIF²⁰ or used for beam combiner designs and applications. Another extremely promising area is the development of gas optics¹⁹: although these are not expected to reach the extreme fluence survivability of plasma-based concepts, they still raise the optics damage threshold by about two orders of magnitude compared to solids, which is already transformative. Gas optics, like plasma optics, also offer similar robustness to debris and radiation.

Herein includes discussion of a concept for high-fluence-resistant gratings to be used in an optical system or laser system such as the final optics of an IFE facility, based on several possible plasma and gas mechanisms. Some such mechanisms can rely on low-energy auxiliary lasers to imprint a grating structure in a gas volume; the grating can comprise, for example, a fully ionized plasma, a partially ionized gas (e.g., with plasma in the “grooves” of the grating and neutral gas between the grooves), or simply a non-ionized, neutral gas. The optical properties of the grating can come from a modulated change in index of refraction produced by, for example, a change of plasma density, a change in gas density, or alternating between plasma and gas. Plasma and gas optics offer several key advantages over the current state-of-the-art glass or solid optical elements used in high-power laser systems: (1) They are robust to debris, x-ray, and neutron fluxes and will not suffer damage when exposed to high-repetition rate high-gain shots. (2) As discussed herein a design based on these gratings can allow all solid-state optics in the laser system to be removed from target line-of-sight, reducing potential damage for fixed components. (3) Gas or plasma gratings can be optically turned on and off, providing shutter-like protection of upstream optics and the laser itself from all backscattering. (4) Both plasma and gas can have high optical damage thresholds, allowing substantially more compact final optic assemblies or significantly more energy in the same cross section. Additionally, (5), this type of grating naturally can support high-repetition rates (>10 Hz).

A combination of an existing plasma or gas optic and existing radiation absorbing blankets and/or debris shields can protect the conventional or non-plasma based or non-gas based or solid-state optics needed to focus intense, high energy laser pulses on targets to produce energy by nuclear fusion in power plants and test facilities. Such a device/system can dramatically improve the lifetime and power handling capabilities of these conventional or non-plasma based or non-gas based or solid-state optics due to the fact that the plasma material from which they are constructed is insensitive to damage by the high energy photons and particles produced, for example, as part of the fusion energy production process. The optics can also withstand high average power, due to rapid radiative cooling of the plasma, can operate at high repetition rate with the plasma material being re-formed from a gas, for example, by each incident laser pulse, and can efficiently deflect the path of light to allow conventional or non-plasma based or non-gas based or solid-state optics in the system to be shielded from ionizing radiation.

In various implementations, an optical system comprises a gas source configured to provide gas to a region for producing a plasma or gas based optic, at least first and second light sources configured to direct respective light beams into the region, and an input light source configured to direct an input light beam to the plasma or gas based optic thereby producing an output light beam. The first light sources, the second light source, the input light source, or any combination thereof are located off-axis of the output light beam.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a schematic illustration of a system including a plasma or gas optic used in directing light to a target. The system further comprises a shield with a hole or opening therein to reduce the emission from the target that reaches optics in the system other than the plasma or gas optics (e.g., solid-state optics in pump or seed sources).

FIGS. 2A and 2B show a fixture for emitting gas that is exposed to light to produce a plasma or gas optic. Such gas may be confined to some extent by a bubble such as shown in FIG. 2B.

FIGS. 2C and 2D are plots showing temperature variation in the plasma optic.

FIG. 3 is a schematic illustration of a shield that may be used to block or attenuate emission from a target illuminated with light.

FIG. 4 is a schematic illustration of a fusion energy plant showing a plurality of beams incident on a target.

FIGS. 5 is a plot schematically illustrating increasing amplified beam power that can be obtained with an increasing number of pump beams.

FIG. 6A is a schematic diagram illustrating the cross-section of a beam such as a seed beam amplified and output from a beam combiner decreasing in size with distance from a plasma region of the beam combiner after being transmitted through the beam combiner.

FIGS. 6B and 6C schematically illustrate the cross-section of a seed beam in comparison to the plurality of pump beams.

FIGS. 7A and 7B are first and second stages of a system configured to illuminate a target with light. The first stage comprises a beam combiner and the second stage comprises an amplifier/compressor.

FIG. 8A is another illustration of an amplifier/compressor such as in the second stage of the optical system shown in FIG. 7B. FIGS. 8B and 8C arc plots of pump depletion and seed amplification for the amplifier/compressor.

FIG. 9 is a schematic illustration of a fusion energy plan showing a plurality of beams incident on a target.

FIG. 10 is a schematic illustration of a system including a plasma or gas optic used in directing light to a target. The system further comprises a shield with a hole or opening therein to reduce the emission from the target that reaches optics in the system other than the plasma or gas optics (e.g., solid-state optics in pump or seed sources).

FIG. 11 is a schematic illustration of a system including a plasma or gas optic used in directing light to a target. The system further comprises a shield with a hole or opening therein to reduce the emission from the target that reaches optics in the system other than the plasma or gas optics (e.g., solid-state optics in pump or seed sources). A plasma optic or a gas optic may be formed by interfering two beams to form an interference pattern to produce a diffractive optical element such as a grating, diffractive lens, etc. in gas or plasma.

FIGS. 12A and 12B schematically illustrate the interference pattern formed by interfering the beams and the resultant index of refraction modulation.

FIGS. 13A and 13B are plots of intensity and change in refractive index with position (normalized by wavelength) showing the intensity variation and resultant refractive index modulation across the interference pattern resulting from different effects.

FIGS. 14A-14C are patterns corresponding to the optical beam interference and resultant index modulation for forming different plasma or gas optics such as a grating, a lens, or a combination of a grating and a lens.

### DETAILED DESCRIPTION OF THE PREFERRED EMBODIMENT

The transition from one-shot-per-day National Ignition Facility (NIF) experiments to the ˜10 Hz operation likely used by an inertial fusion energy (IFE) facility poses substantial challenges for laser drivers. The target-facing final optics will likely be subject to significant x-ray, neutron, backscatter, debris fluxes, or any combination of these while delivering enormous per-pulse energy and average power to target. In various systems described herein, a different type of optic, e.g., a transient gas or plasma volume grating produced by small secondary lasers, may offer a solution for the final optical component(s) of a high-repetition-rate IFE system or facility. Such optics (e.g., transmission optics) may be based on induced index of refraction modulation in a gas or plasma and can be used, for example, for beam steering and focusing as well as other applications such as beam combining and/or amplification. Such plasma or gas based optics may be orders-of-magnitude more resistant to optical damage than solid-state materials, e.g., glass, and, plasma or gas based optics can be reformed with each shot and/or are not affected by debris or radiation. As a secondary benefit, their short lifetime means that such plasma and/or gas based optics act as fast optical shutters to protect upstream laser optics from all backscattering. Using plasma and gas optics such as gratings, beam combiners, amplifiers, can allow solid-state optics (e.g., some, most, or all solid-state optics) to be removed from a target line-of-sight, improving the resilience and lifetime of any future IFE facility. (As discussed herein, solid-state optics includes glass optics despite glass potentially comprising a liquid.)

As described herein, a device can replace the conventional or non-plasma based or non-gas based or solid-state, final optics in a multi-beam laser fusion chamber. This new device can comprise both a plasma optic and a thick radiation shield with a small hole in the center. This plasma optic may work by transferring energy from several laser beams into a single beam by using a plasma optical component that is created near a small hole behind a large radiation shield that sits between the conventional or non-plasma based or non-gas based or solid-state optics and the target chamber center. Some, most or all conventional or non-plasma based or non-gas based or solid-state optics of the laser beams, with the exception of a single beam, may be shielded from line of sight to the target chamber center, are protected, and not exposed to radiation coming from the fusion target at the center of the chamber dramatically reducing their maintenance costs. In some designs where the plasma optics provides beam combining and/or amplification, the gain in the plasma optic allows the single un-protected beam to operate with a small area and optical fluence allowing it to be maintained at reduced cost. In some implementations, the plasma optic comprises a beam combiner and/or beam amplifier. The plasma optic may, for example, use scattering from diffractive cells of plasma ion waves formed by the multiple intense incident beams that are impervious to ionizing radiation to redirect and redistribute the beams energy and power and when used with laser, radiation shielding and fusion target design techniques, may allow the conventional or non-plasma based or non-gas based or solid-state optics in a laser facility producing fusion power to be shielded from ionizing radiation associated with fusion. In various implementations, an optic is made of plasma and it is itself essentially impervious to damage from either the beams themselves or from the ionizing radiation. Accordingly, this optic has application in laser fusion power plants where it will dramatically reduce facility maintenance and operational costs and potentially other applications where energetic lasers are used to drive emitting targets. While plasma-based optics are discussed herein, in various implementations, the gas-based optics may be used.

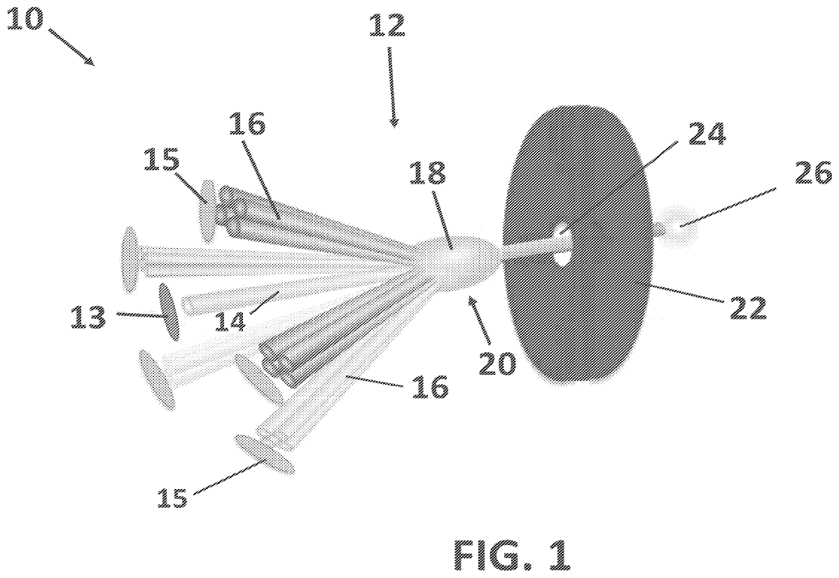

When combined with existing laser design, fusion target design and radiation shielding techniques, FIG. 1 illustrates how these plasma optics are capable of delivering fluence and intensity to the fusion target that is un-precedented by systems using solely conventional or non-plasma based or non-gas based or solid-state optics and can allow conventional or non-plasma based or non-gas based or solid-state optics to be shielded from the fusion reaction products to dramatically improve component life times and economy of operation of the power plant. FIG. 1 shows, for example, a system 10 comprising a beam combiner 12 comprising a seed beam 14 from a seed beam source 13, a plurality of pump beams 16 from one or more (e.g., a plurality of) pump beam sources 15 converging, overlapping, and or coming together at a plasma 18 formed by providing gas from a gas source at the location of convergence of the beams. The gas may be ionized and heated with heater beams (not shown). A plasma-based optic 20 is formed in this plasma. This plasma-based optic 20 may comprise, for example, a beam combiner or amplifier or other component in various implementations. The seed beam source 13 and pump beam source 15 are represented by respective optical elements in FIG. 1, which may comprise non-plasma based, non-gas based or solid-state optics or optical elements. As discussed above, solid-state optical elements can include glass optical elements or other optical elements that may otherwise be consider as comprising a liquid. The seed beam source 13 and/or pump beam source 15 may comprise lasers or laser systems. The seed beam 14 may have a wavelength (λₒ) of 351 nm in some designs. The pump beams 16 may have a wavelength (λₒ+Δλ) of 351 nm in some implementations. More or less pump beams 16 (and thus pump beam sources 15) may be included. The beam combiner may provide an 8 kJ and a 1 ns output or more or less or longer or shorter. FIG. 1 also shows a shield 22 such as a radiation absorbing and/or blocking or attenuating shield. The shield 22 has a hole or opening 24 through which the seed beam 14 passes. FIG. 1 also shows a target 26. The seed beam 14 is incident on this target 26. This target 26 may comprise a radiation producing target. The shield 22 may absorb and/or block radiation produced and/or emitted by the target 26 and may be able to provide protection to some non-plasma based, non-gas based, or solid-state optics such as in the seed source 13 and/or pump sources 15.

The system 10 of FIG. 1 can be described as including four components, which when combined and suitably configured (possibly optimized) can allow a radiation producing target 26, such as is used for IFE, to be driven by a conventional laser facility or a laser facility with conventional or non-plasma based or non-gas based or solid-state optics shielded from damage by the target emissions. As discussed above, FIG. 1 shows the four elements: 1) a plasma optic 20 produced by wavelength shifted beams 16 interacting in a gas (red, blue and orange), 2) the radiation producing target 26 (white and grey) 3) a radiation absorbing shield 22 (black), and 4) optics in a conventional laser 13, 15 or laser having non-plasma based, non-gas based, or solid-state optical elements producing pump beams 16 (green). When these components are assembled, the models of plasma optics that have recently been demonstrated as predictive may allow them to be improved or optimized for the specific needs of a wide range of fusion energy power plant and test facility designs.

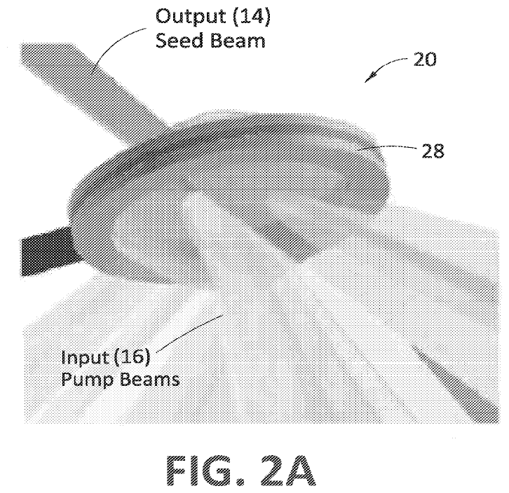

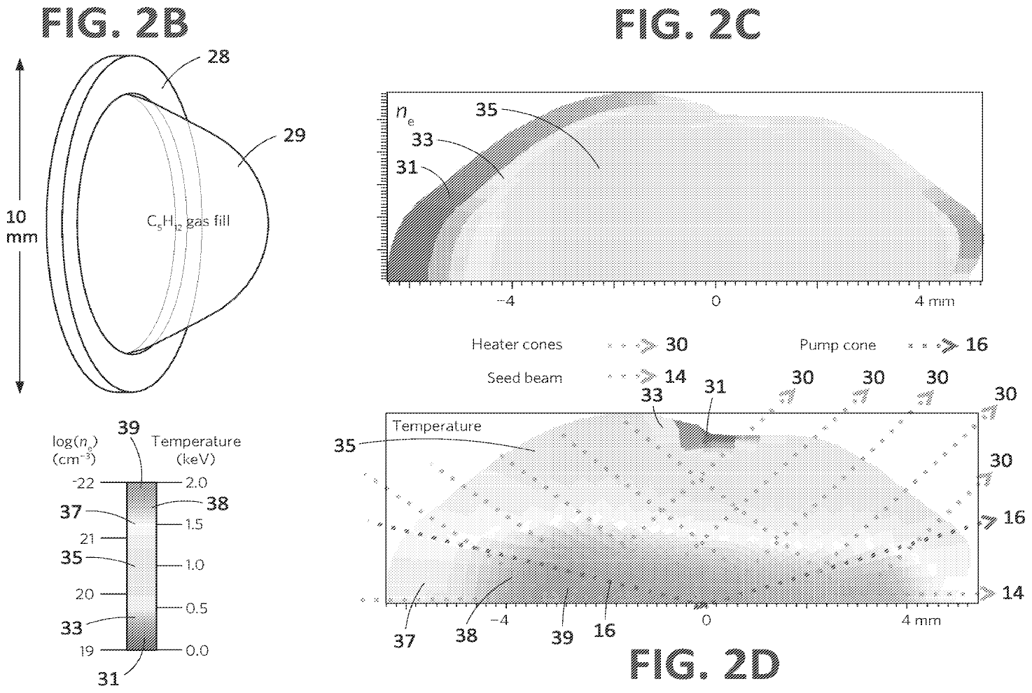

This design, comprising a beam combiner or amplifier 12, takes advantage of recent studies and demonstrations of the scattering cells formed by intense lasers propagating in plasmas which have shown that the process of Stimulated Brillouin Scattering (SBS) can allow a scattering cell to form that precisely re-directs energy flowing in the paths of the many incident laser beams to change direction and follow the path of one or more (e.g. a few, other beam(s)). The scattering can be controlled by small adjustments in the frequencies of the different beams. The models of these process are now sufficiently well-developed that they accurately predicted the power in the transmitted beams and their focal properties [1,2] and have been used to design such optics 20 for other applications as shown in FIGS. 2A-2D. FIG. 2A, at the top, is an example of plasma based final optic 20 that has been demonstrated to work under conditions applicable to a fusion power plant where it would redirect light from multiple input laser beams 16 incident at different angles (orange and yellow) to propagate in the single output beam 14 (red) for delivery to a target 26 of fusion fuel (not shown, in upper left). FIGS. 2A and 2B show the plasma based optical element 20 formed by a gas provided by a fixture (e.g., gas emission fixture) 28 possibly further comprising a balloon 29 for holding the gas. The existing designs of gas filled balloon targets that create the plasma with pre-heating beams 30 allow pump beams 16 to be propagating at different angles than the output beam 14 [1,2]. This use of the plasma optic 20 also allows the final optics of some, most or all pump beam sources 15 of some, most or all pump beams 16 to be placed behind radiation absorbing material 22. The material's thickness and location is configured, e.g., possibly optimized, with existing techniques to protect them from some, most or all products of the nuclear reactions in the target 26. FIGS. 2C and 2D show variation in temperature 31, 33, 35, 37, 38, 39 in different location within the plasma region.

Advantageously, optical components can thus be designed and tested, that are made of plasma and that can withstand the beam fluence and intensity for producing energy by laser driven fusion in power plants with a wide range of specific designs and laser and component shielding requirements, and which can potentially operate indefinitely without repair or replacement in the high radiation environment of such a plant.

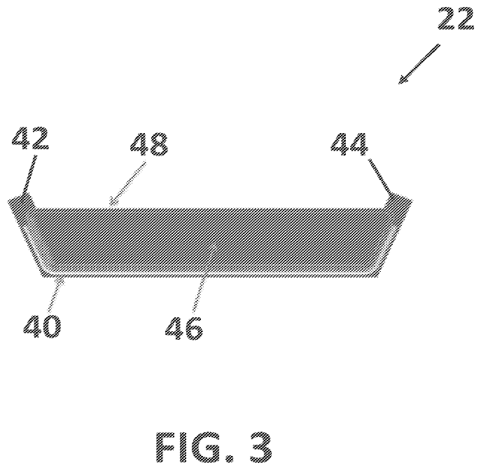

FIG. 3 illustrates an example shield 22. The shield 22 of FIG. 3 is formed with a first wall tube 40, a first wall injection plenum 42, and a first wall extraction plenum 44. The shield 22 comprise a blanket bulk 46 as well as blanket skin 48. In various implementations, the blanket bulk 46 is 70 cm thick, and the wall tube 40 is 10 cm in diameter. The thickness of the wall or shield 22 may be 80 cm. Larger or smaller designs and dimensions are possible. FIG. 3 shows an example of existing designs of radiation shields 22 for fusion energy power plants [6] that can have as little as 10 cm diameter pipes of liquid Li in the first wall and is sufficient to dramatically reduce the thermal load on material behind the wall, while up to 80 cm of material can effectively protect material from both thermal load and other radiation induced damage in this application. Still other designs (e.g., optimizations) have shown that as little as 2 cm of shielding can protect material against the most severe heat load from the radiation source as discussed in the text.

Studies of laser fusion reactor concepts have found that the final optics of the laser system will be exposed to fusion reaction products streaming straight back from the fusion fuel to the optic that produces the beam that drives the fuel [3-6]. As a result, the replacement of these optics would be expected to be a major cost driver for the operation of the plant, if the optics were made out of conventional or non-plasma based or non-gas based or solid-state materials [3,4,5,6]. (As stated above, glass may be considered a solid-state material.) Various design concepts described herein employ plasma optic formation to design efficient stand-alone optical components that will deflect the incident laser beams at the suitable (e.g., possibly optimum) angle and location to allow sufficient shielding material to be placed between the fusion reactions and the conventional or non-plasma based or non-gas based or solid-state optics in the laser facility to adequately protect them. These designs can potentially rely on the established techniques of laser facility design, radiation shield design and fusion target design as components, and may be individually designed (e.g., optimized) for the specific application. As discussed above, FIG. 1 shows an example of how four potentially existing components [4,5,6], including a plasma optic 20 can shield conventional or non-plasma based or non-gas based or solid-state optics. In this particular scenario, the plasma was produced with the laser beams 16 incident on a polyimide bubble or balloon filled via a tube with a C₅H₁₂ gas and may also be produced with other gas systems (such as pressure jets) or low density foams as each application demands. In particular, as discussed above, the components may include the following:
(1) The plasma optic technique [1,2] for which the geometry shown in FIG. 1 and details of FIGS. 2A-2D are an example, will create the desired optic properties in a plasma 18 created by an initially low density gas held near the focus of the intense beams that illuminate it, with the direction, wavelength, and focal properties of the beams in the optic 20 configured (e.g., possibly optimized) to protect (e.g., best protect) the specific laser facility from any specific configuration of reacting fusion fuel that may be of interest for producing fusion energy, and is expected to find wide applicability.
(2) The specific targets 26 considered in the hot spot ignition scenario, for example, described in Ref. [4, 5, 6], can be driven with a plasma optic 20 that can be placed, for example, from 2 cm to 80 cm from the target to achieve the desired space for shielding the conventional or non-plasma based or non-gas based or solid-state optics so that their lifetime is adequate for the specific application.
(3) A radiation shield 22 designed with materials to absorb the expected ionizing radiation (e.g., the x-ray and/or gamma ray photons, as well as possibly fusion alphas and/or neutrons and/or the remaining target material and/or chamber fill gas material) when placed in radiations path to the radiation sensitive components. Existing designs of shields 22 have been developed to protect other structural material in the power plant from the bulk of the highest energy per volume heat loads, and in some cases may use only 10 cm of space for a liquid Li cooling tube to protect the shielded components from that thermal heating, while possibly up to 80 cm of space will allow a combined Li cooling and neutron absorbing blanket to shield components from both the heat and other (e.g., all other) effects of radiation induced damage such as ionization and/or dislocation as shown in FIG. 3 (see, e.g., Ref. [6]). A further existing change (or possibly optimization) of shield design can avoid the use of high Z gas fill in the target chamber and has shown that a LiPb coolant can protect against the expected maximum thermal loads of fusion power applications [3] even when <2 cm of space is created for the shield 22 (possibly conforming to the geometry of FIG. 1 and the presently demonstrated plasma optic performance [1,2]). Use of these shields 22 to protect conventional or non-plasma based or non-gas based or solid-state optics is made possible with design concepts described herein. Some such implementations use radiation hard plasma optics to deflect the laser light through a >˜2 mm diameter hole or opening 24 in the shield 22 as shown in FIG. 1, creating a region of the needed dimension for a shielding material to be placed in the path of the ionizing radiation but not in the path of the incident light. Accordingly, in various implementations, the shield 22 is not in the path of the seed beam or the incident light beam 14 directed onto the target 26.
(4) A laser facility to drive the fusion target such as the one that can deliver 10 to 20 ns pulses of 351 nm laser light to produce fusion reactions in the target, e.g., described in Refs. [4,5,6]. With various design concepts described herein, the facility may benefit from dramatically reduced radiation on most of its conventional or non-plasma based or non-gas based or solid-state optics, and can be further designed (e.g., possibly reoptimized) to make even the remaining, unshielded optics operate at substantially reduced fluence (e.g., possibly due to the >10x gain of light from the un-shielded conventional or non-plasma based or non-gas based or solid-state optics by the plasma optic), allowing existing low fluence conventional optics hardening solutions (such as liquid mirrors or small area optics replaced with robotic arms [3]) to be used for this system to substantially reduce its maintenance and replacement costs as well.

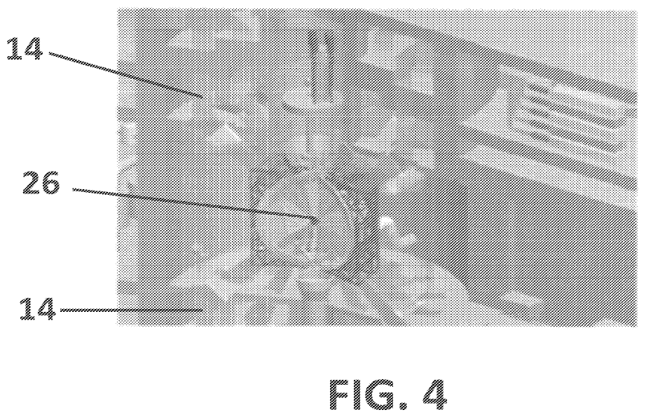

FIG. 4 is an example, see, e.g., Ref [4,5], of a fusion power plant design with conventional or non-plasma or non-gas or solid-state final optic components conveying seed beams 14 and that are placed outside the region protected by radiation shields (green region), and allows a direct path for radiation emitted from the fusion target (red) 26 to impinge on the final optics remaining in that path (blue region). As such radiation damage of those final optics may be a substantial driver of power plant maintenance and cost. Various design concepts described herein may allow optics in the direct path of radiation to be made from plasma that is impervious to radiation damage, which dramatically increases the components lifetimes and reduces costs of power production.

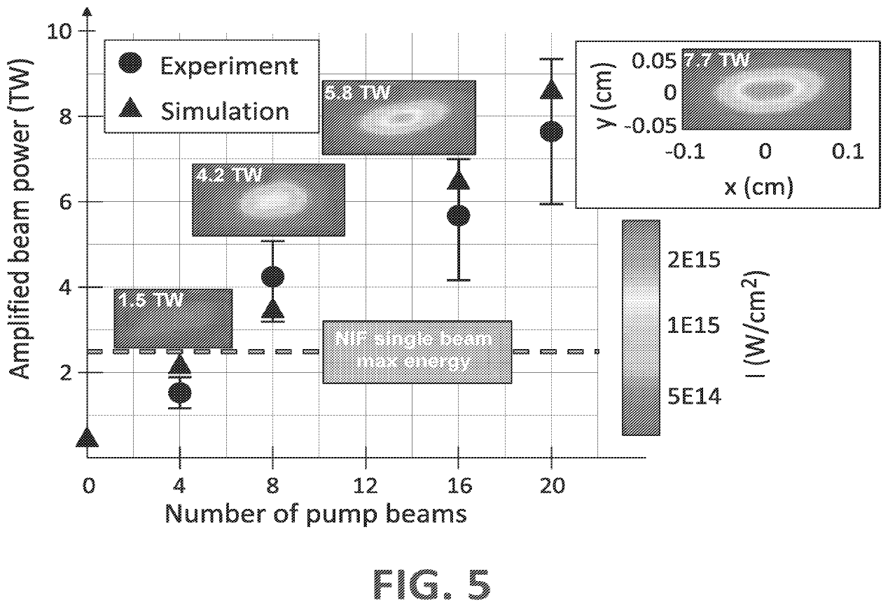

Design concepts described herein can be employed for different designs. Accordingly, a wide range of variations are possible. For example, as discussed above, the number of pump beams 16 may be larger or smaller. FIG. 5, for example, shows a plot, on axes of amplified beam power versus number of pump beams 16, that illustrate how more pump laser 15 and pump laser beams can increase the amplified beam power.

X-ray images confirm expected power/fluence. For example, a twenty-one (21) beam combiner amplifies a NIF beam 10x to deliver 40% of pump energy to a (fusion) target in a Ins pulse with a 1 mm² spot.

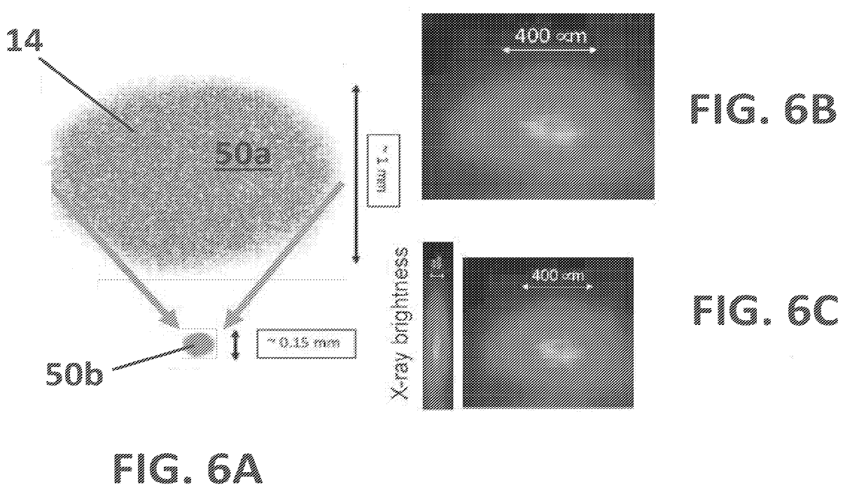

In addition to combining the power of pump beams 16, the plasma optics 20 may focus the beam. As illustrated in FIGS. 6A-6C, the beam combiner 12 output beam demonstrates focusing after transmission, enabling smaller spots. As illustrated in FIG. 6A, beam combiner 12 continues to focus after amplification. Pump with CPP, and obtain defocused seed spot 50a in plasma optic 20 as shown in FIG. 6A. The seed beam 14, however, continues to focus 22 mm in vacuum. As illustrated, the seed beam cross-section has a reduced size. FIG. 6A shows the seed spot 50b when reaching best focus (e.g., reduced cross-section or spot size) after passing through plasma optic 20. FIG. 6B shows the large pump and smaller seed spots 50b in plasma optic 20 of the beam combiner 12. FIG. 6C illustrated the smaller amplified seed spots demonstrated on witness plate.

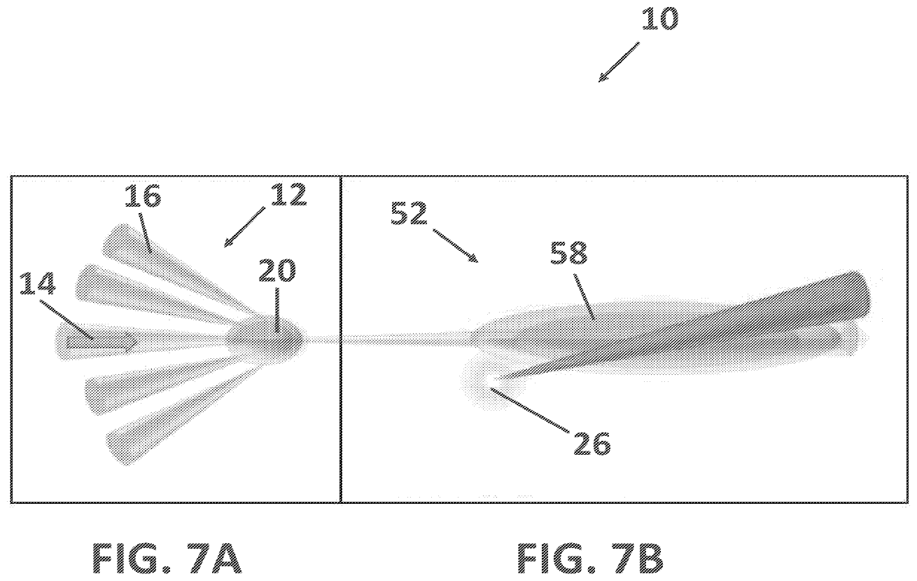

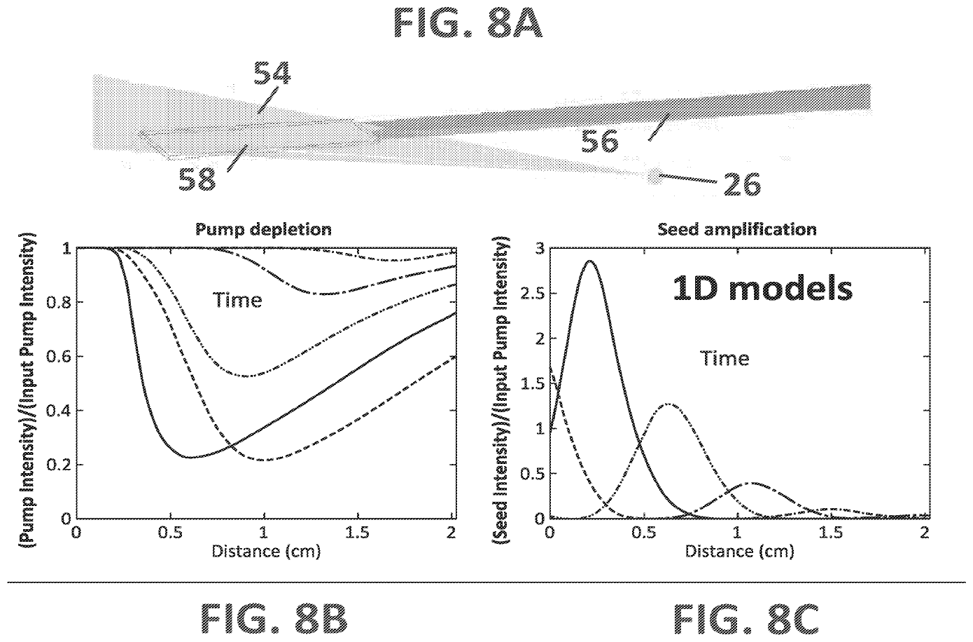

Various implementations may include a multi-stage optical system 10. As illustrated in FIG. 7A, the optical system 10 may comprise for example a first stage comprising a beam combiner 12. As illustrated in FIG. 7B, the optical system 10 may comprise, for example, a second stage comprising an amplifier/compressor 52. Models show a second stage plasma optic can further compress the nanosecond beams to become 10's picoseconds and may thus potentially deliver 10's kJ with existing lasers. A plasma optic could be developed to potentially provide 10's of kJ in a short pulse from 20 to 40 NIF beams. The remaining beams may be used to compress fusion fuel. FIG. 7A shows Phase 1 of the system 10 comprising a plasma combiner 12 such as for example described above. FIG. 7B shows Phase 2 of the system 10 comprising an amplification/compression stage 52 providing, for example, short pulse (<100 ps) amplification/compression. Possibly 20 to 40 pumps could be used to increase energy. A high mode quality seed could be employed. Large scale plasma 58 could be used for the second stage amplification/compression. The pumps could be 10 ns and the seed could be 10's of ps seed. This system 10 could provide the highest intensity/fluence on assembled fusion fuel 26. FIG. 8A shows an amplifier/compressor 52 comprising a pump beam 56 (e.g., a high energy long pulse pump) and seed 54 (e.g., short pulse focusing seed) incident on a plasma 58 such as a plasma slab. FIGS. 8B and 8C show pump depletion and seed amplification as a function of distance. Plots of the pump depletion and seed amplification for different times are shown. A facility designed to drive tested plasma optics could potentially deliver 100's kJ in 10's of ps to small spots as needed, for example, for a F.I. fusion plant. Recent demonstrations of plasma optics amplifying beams that continue to focus to the final target support a concept for second stage short pulse compressor/amplifier 52 that operates with plasma 58 and beams conditions that can be tested at smaller scale. Confirming models could enable IFE demo plants to be designed with plasma optics.

Accordingly, plasma based combiners, amplifiers, compressors and other plasma optical components may be used and/or designed for specific applications. In various implementations ion wave plasma optics could be employed although other plasma optics may be possible. As discussed herein, gas based optics may also be employed in various cases.

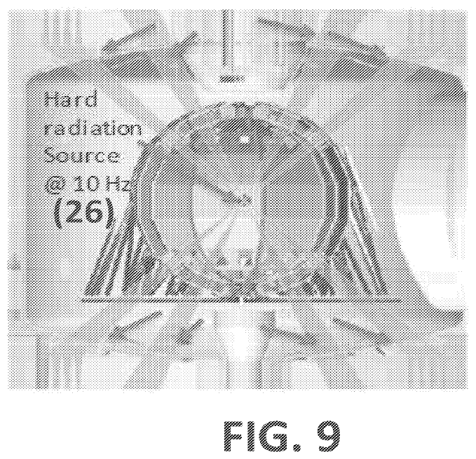

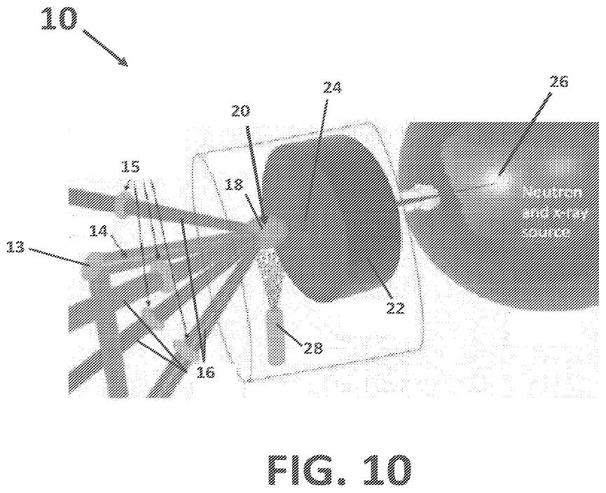

Various designs and design concepts described herein may be employed, for example, in Inertial Fusion Energy plants such as future IFE plants and near term IFE power plants. IFE targets are source of extreme radiation @ 10 Hz. 12% output is in 100 keV X-rays+neutrons. FIG. 9 shows an example inertial fusion energy power plant. Final optics in, for example, the beams source that provide beams are exposed to harmful emission from the target 26. FIG. 10 shows a system 10 comprising plasma optics 20 as the final optics. As illustrated, a gas line 28 (or other fixture configured to provide the constituent(s) from which plasma is produced) outputs gas (or other constituent(s) from which plasma is produced) to form a plasma 18. FIG. 10 depicts pump beams 16 from pump sources 15 converging on the gas emitted by the gas line 28 and the plasma 18. The seed beam 14 from the seed source 13 is also shown directed into the plasma 18. A shield 22 is shown between the pump sources 15 and the target 26. The shield 22 has an opening 24 therein. This opening 24 is positioned with respect to the seed source 13 to receive the seed beam 14 such that the seed beam passes through the opening. The shield 22 and the opening 24 are additionally positioned and configured such that emissions from the target 26 that would otherwise be incident on the non-plasma based or non-gas based or solid-state optics, for example, of the pump sources 15 (and possibly portions of seed source 13) possibly block or at least attenuating such emissions. Designs and design concepts provided herein such as based on plasma optics or gas optics can thus provide solutions to protect the final optics in laser-based IFE power plants, other than frequent replacement. Such solutions may impact facility cost, for example, costly final optics and maintenance down time. As discussed herein, radiation-hard plasma optics can have an impact on Inertial Fusion Energy. Additionally, implementations may be employed for laser diagnostics on non-laser based high yield facilities. Plasma optics are inherently radiation-hard, one-shot optics that may not require much replacing or downtime. Thus, it may be possible to design highly efficient plasma optics device with experimentally validated models and test near full-scale on NIF.

In various implementation, the geometry of the beams forming the plasma optic and driving the fusion target and the gas target upon which they impinge has dimensions and incidence angles similar to existing plasma optics demonstrations [1,2] such as that are shown in FIGS. 1 and 2 and will operate with the beams focal spot size and location, as well as the wavelengths f/numbers and angles of incidence. However, such parameters and the resultant designs may be adjusted to (e.g., optimally) drive the specific fusion target in the presence of the shielding material for the respective application. Likewise, the needs of specific applications for protection of the conventional or non-plasma based or non-gas based or solid-state optics from heating and/or other types of radiation damage may vary as may the specification for and/or requirements placed on the plasma optic 20 by each application that may involve a specific design and possibly optimization. Useful implementations of the design concepts described herein are expected not only for fusion power plants needing and/or possibly benefiting from extended optics lifetime but also for near term test facilities developing fusion energy for a range of applications with their own requirements on radiation production rates and optics lifetime. Thus, various implementations described herein include employing plasma optics, along with a radiation shield, to protect the final conventional or non-plasma based or non-gas based or solid-state optics of the beams that are being combined, and thus form an improved (possibly optimized) final optical system that is impervious to the radiation environment of any specific laser fusion power plant or test facility. Previously existing designs of laser fusion power plants [4, 5 and references therein], such as shown in FIG. 4, rely heavily on expensive, conventional or non-plasma based or non-gas based or solid-state, final optics that have a direct line of site to the fusion target at the chamber center, and therefore may be routinely replaced due to damage from the radiation products. The application of the designs and design concepts disclosure herein may also be used for different application.

Other variations are possible. For example, the specifics of the plasma optic assembly (plasma optic plus radiation shield) can also be designed (e.g., possibly optimized) to cover the full range of laser beam pulse shapes and durations as well as focal properties which are useful, for example, for the wide range of existing fusion target designs.

Additionally, as discussed above, the designs and design concepts should not be limited to plasma optics but also include gas optics. Furthermore, the designs and design concepts should not be limited the combiners, amplifiers, and compressors such as described above. For example, the plasma and gas based optics may comprises gratings and/or lenses applicable for a range of purposes including but not limited to beam steering and focusing.

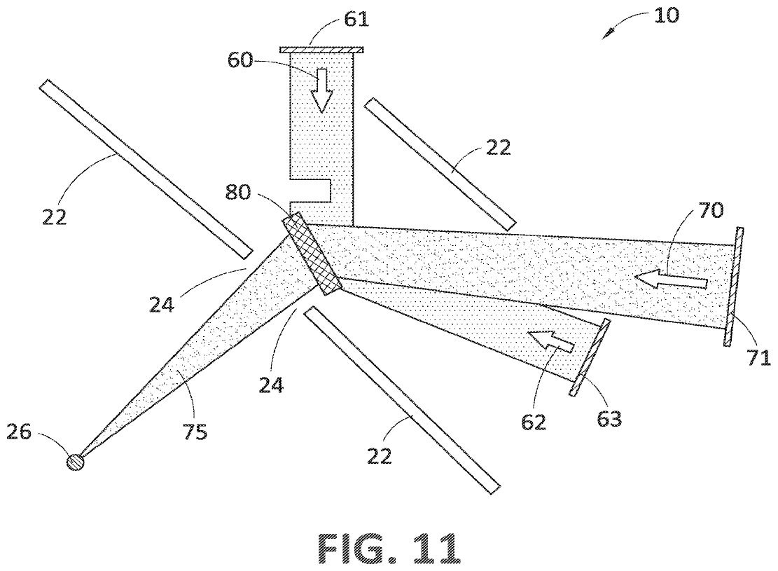

An example application for a beamline in an IFE facility is schematically shown in FIG. 11, where the use of a plasma or gas grating 80 is configured such that all the solid-state optical elements in shielded areas, with the driving laser steered around a debris shield 22. In particular, FIG. 11 shows a system 10 comprising a plasma optic 80, comprising, for example a grating upon which a light beam (which may be referred to as input beam, seed beam, input seed beam and may be a laser beam, input laser beam, or seed laser beam, etc.) 70 from a light source or laser source 71 (which may be referred to as input source or input light source or seed source or laser or input seed source or laser) is incident. The input beam 70 is incident on and transmitted through the plasma optic 80 and is directed to a target 26. (This input beam 70 transmitted through the plasma optic 80 and directed to the target may be referred to herein as the output beam or output laser beam 75.) The input or seed source 71 (or input or seed laser or laser source) may include non-plasma optics, non-gas optics, or solid-state optics. Such non-plasma optics, non-gas optics, or solid-state optics, and in particular, the optics of the input source 71 closest along the optical path of the beam 70 to the plasma optics 80, may comprise non-plasma optics, non-gas optics, or solid-state optics that may be shielded from harmful emission from a target 26 by one or more shields 22.

FIG. 11 additionally shows first and second beams 60 and 62, for example, first and second laser beams interfering at the location or region where the plasma optic 80 is formed. In various implementations, for example, gas is emitted by a gas line and the first and second laser beams 60 and 62 are configured to interfere at the location or region where this gas is located. In some implementations, the first and second laser beams 60, 62 may have sufficient intensity to transform at least a portion of gas into a plasma thereby forming the plasma optic 80. In various implementations, for example, interference of the first and second laser beams 60 and 62 produce interference fringes that can form a plasma grating and/or a plasma diffractive lens or possibly other diffractive optical element from the gas illuminated by the first and second laser beams. (In some cases, these first and second beams or laser beams 60, 62 may be referred herein to as pump beams or pump laser beams.) The first and second beams 60, 62 are shown produced by first and second light sources or first and second lasers 61, 63 (which may be referred to herein as beam pump sources or pump beam sources). These first and second sources or lasers 61, 63 have optics (shown) closest along the optical path of the respective beam 60, 62 to the plasma optics 80, which may comprise non-plasma optics, non-gas optics, or solid-state optics. Such non-plasma optics, non-gas optics, or solid-state optics, and in particular, the optics of the light or laser sources 61, 63 may comprise non-plasma optics, non-gas optics, or solid-state optics that may be shielded from harmful emission from a target 26 by one or more shields 22. The plasma optics 80, however, need not be shielded from emission from the target 26 by the one or more shields 22. Rather, a hole, opening or separation 24 within a shield or between shields may permit the laser beam (output beam) 75 transmitted through the plasma optics 80 to be incident on the target 26. Likewise, emissions from the target 26 would be permitted to be incident on the plasma optics 80 through the hole, opening or separation 24 within the shield or between shields 22.

Accordingly, FIG. 11 is a scheme or configuration showing the plasma grating 80 being used as the final optics in an IFE experiment or IFE fusion power plant. The plasma grating 80 is in the target 26 line of sight but can sustain the neutron and x-ray flux (and possibly the high fluence from the driver laser itself), while all the solid (e.g., glass) optics are positioned behind some shielding 22 and thus not in the line of sight of the target. Similarly, in the system 10 shown in FIG. 11, the first and second beams 60, 62 and/or light sources 61, 63 (which may be referred to as pump beams and beam pump sources, respectively or pump laser beam or pump lasers) are not coaxial with the input beam 70 (input laser beam) incident on the plasma optic 80. Instead, the first and second light sources are off-axis with respect to the input beam 70 (input laser beam) incident on the plasma optic 80. Similarly, the first and second beams 60, 62 and sources 61, 63 (pump beams and source or pump laser beams and laser sources) are not coaxial with the output beam (output laser beam) 75 that is transmitted through the plasma optics 20 and directed to the target 26. Instead, the first and second beams 60, 62 and/or light sources 61, 62 are located off-axis of the output beam 75.

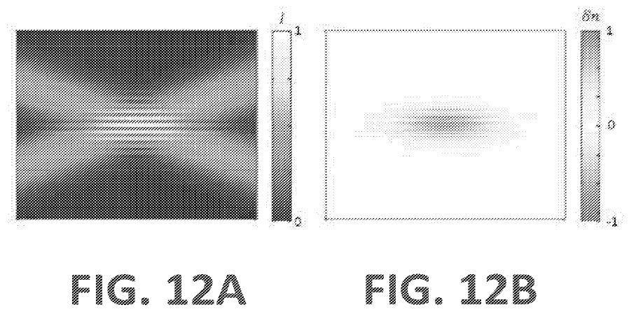

FIG. 12A is an illustration showing two crossing laser beams with their interference pattern (e.g., fringe pattern). FIG. 12B is an illustrating showing the resultant imprint on a refractive index modulation in a gas or plasma. The variation in optical intensity causes by the interference pattern translates into a variation in index of refraction of a gas or plasma in a gas or plasma optic.

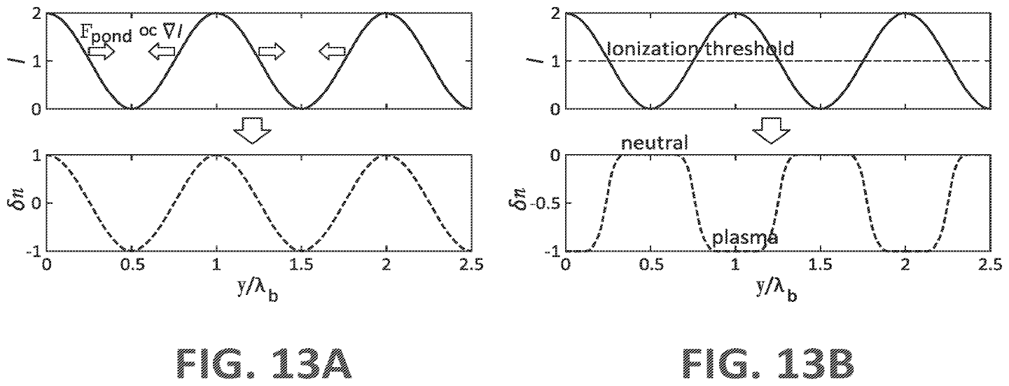

FIGS. 13A and 13B, for example, are illustrations of two physical mechanisms behind the creation of an index modulation. FIG. 13A depicts index modulation via the ponderomotive force (“F_{pond}”) in a fully ionized plasma, which expels charged particles from high-intensity regions. FIG. 13B depicts index modulation from localized ionization, when the peak intensity of the interference pattern is right above the ionization threshold.

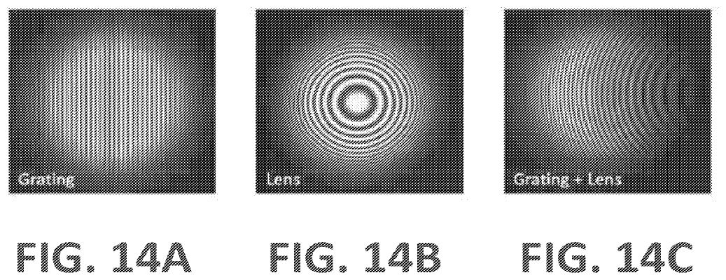

FIGS. 14A-14C are examples of index modulations (e.g., pump lasers interference patterns) for a grating, a diffractive lens (e.g., a plasma-based Fresnel zone plate), and a focusing grating. Interference of two plane waves may create an interference pattern such as shown in FIG. 14A that forms a linear grating. Interference of two spherical waves or a spherical wave and a plane wave may create an interference pattern such as shown in FIG. 14B that forms a diffractive lens. FIG. 14B shows an interference pattern that additionally includes tilt. Such gratings may be used for beam steering (e.g., redirecting beams, changing the direct of the beam, focusing or defocusing beams, or any combination thereof). Other diffractive optical elements that perform other operations are also potentially possible.

### Physical Mechanisms for Plasma and Gas Optics

Plasma and gas gratings may rely on the nonlinear response of a plasma or neutral gas to the intensity pattern of several overlapping lasers, allowing these lasers to create a refractive index modulation from their intensity interference pattern. The simplest example is that of a grating created by two lasers, as illustrated in FIG. 11. Once created, this grating can act as a Bragg mirror or grating for another laser beam incident at the Bragg angle. There are many nonlinear physical processes that can in principle be exploited to create such a structured index modulation in a plasma, gas, or other material. For IFE applications, the schemes that may be particularly useful are where the underlying medium has a significantly higher damage threshold than solid-state optics, either from optical damage from the laser itself or from the extreme x-ray and neutron flux from an IFE environment. Three mechanisms are of particular interest:
1. Index modulations generated by density modulation in a neutral gas¹⁹;
2. Density modulations in a fully ionized plasma (e.g. plasma gratings used in ICF9);
3. Index modulations resulting from ionizing a neutral gas only in the brightest fringes¹¹.

The second and third mechanisms are illustrated in FIGS. 12A-12B. All three methods can be investigated with theory, simulations, and experiments, focusing on their relative benefits and disadvantages as well as scalability to the IFE parameter space.

It is possible to extend this concept beyond gratings that are essentially one-dimensional structures, and design two-or three-dimensional structures. One recently pertinent example is the diffractive plasma lens¹¹, created by two pump lasers with different focusing geometries, as opposed to two quasi-plane waves crossing at an angle for a grating. Following the same idea one can in principle design a focusing grating, which may be useful for IFE applications in a geometry similar to FIG. 11.

### Practical Considerations for the Design of a Plasma Optic

Several properties may govern the viability of a particular plasma or gas optic approach for a specific application. Values that current experimental results suggest different mechanisms can provide, as well as what is likely to be useful for an IFE facility using gas or plasma optics are discussed below.

Diffraction efficiency: A key parameter for assessing a grating-or any optic-is its efficiency; substantial losses due to inefficient diffraction will make a gas or plasma grating nonviable for IFE applications. However, despite the difficultly of working with plasma, experimental results are promising. Gas gratings have been demonstrated that provide 95% diffraction efficiency¹⁹. Efficiency for fully ionized plasma gratings is estimated to be over 50% in many ICF experiments using significant crossed-beam energy transfer for symmetry tuning and in beam combiner experiments. Recent work has also shown efficiencies above 50% for ionization gratings²⁰.

Grating modulation strength: The strength of the refractive index modulation determines the optical path length inside the grating for efficient diffraction: a stronger modulation allows a shorter grating. This then determines the spectral bandwidth that can be controlled. Index modulations of 10⁻² for ionization gratings, 10⁻⁴ for plasma gratings, and 10⁻⁵ for gas gratings, may be possible, all of which are sufficient for nanosecond ICF driving lasers.

Damage threshold: Ponderomotive gratings are likely to have the highest damage thresholds, above 10¹⁷ W/cm² for femtosecond and picosecond pulses, although likely longer for nanosecond pulses. Ionization gratings have short-pulse damage thresholds around 10¹⁴-10¹⁵ W/cm², although again performance may be less clear and likely to be lower for nanosecond pulses. Neutral gas gratings have been demonstrated with damage thresholds around 1 kJ/cm² for nanosecond pulses, orders-of-magnitude above the capability of glass optic.

Grating lifetime: Gratings in neutral ozone gas have standing-wave spatial structures that oscillate in time with periods of about 100 ns, making them particularly well-suited for manipulating long pulses, on the order of ns to tens of ns. Gratings in fully ionized plasma driven by the ponderomotive force (FIGS. 12A-12B) can last for as long as the pump lasers are present to maintain them. Gratings based on localized ionization have lifetimes of tens to hundreds of picoseconds. While this, and the large index modulations possible, make ionization gratings more suitable for short-pulse manipulation, it may be possible for lifetimes to be extended to the nanosecond regime. Note, grating lifetimes no longer than the driving laser pulse may be desirable for protecting the laser system from backscatter; for a target meters away from the grating, these mechanisms likely meet that metric.

Overall Efficiency: The overall efficiency may refer to the overall energy budget when including the laser energy in the “pump” beams. Gas gratings can be created by UV beams with much lower energy than the beams being subsequently manipulated. It was estimated that the scheme from Ref. 13 would allow the control of a kJ laser of infrared or visible light using less than 50 mJ of energy for the pumps. Likewise, ionization gratings can be very efficient, involving relatively modest energy in ultra-short (fs) laser beams to create index modulations that can last for tens or hundreds of picoseconds and manipulate lasers with much higher energies. Both schemes can be further adjusted (possible optimized) by selecting appropriate wavelengths for the pumps, to increase the absorption in the gas (for the gas grating) or ionization (for the ionization grating). Ponderomotive gratings can be very efficient for short (picosecond) durations by relying on ion motion inertia but for nanosecond pulses might involve substantially more energetic pump lasers to hold the grating fringes in place.

Accordingly, designs may include high-fluence-resistant gratings and/or lenses using, for example, three novel techniques: density modulations in neutral gas, localized ionization in neutral gas, and ponderomotive force in fully ionized plasma. The strengths of these concepts for IFE applications are:
High optical damage thresholds (several orders-of-magnitude above glass)
Suitability for high repetition rates (>10 Hz)
Robustness to debris, x-ray, and neutron fluxes
Protection of solid-state optical components from direct exposure to targets, and
Shutter-like protection of upstream laser optics from backscattering.

The technology described herein has the potential to transform the application of high-power lasers both within and beyond inertial fusion energy. Accordingly, applications and configurations should not be limited to fusion energy. Likewise, the plasma or gas optics may comprise gratings, lens, combiners, compressors, amplifiers or any combination of these as well as possibly other optical clement or devices.

Other variations are possible. For example, gas or gas based optics may be used in any of the examples above in place of plasma optics. Any one of the light sources may be lasers or laser light source although the designs should not be limited to those.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no clement or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

### REFERENCES

Please see, for example, one or more of the following documents in connection with the subject matter to which these references are cited above.
[1] R. K. Kirkwood, et al., “Plasma-based beam combiner for very high fluence and energy,” Nature Physics 14, 80-84 (2018).
[2] R. K. Kirkwood, et al., “A plasma amplifier to combine multiple beams at NIF,” Physics of Plasmas 25, 056701 (2018).
[3] T. Norimatsu, et al., Nucl. Fusion 57 (2017) 116040
[4] https://en.wikipedia.org/wiki/Laser_Intertial_Fusion_Energy
[5] Dunne, M. et al. ‘Timely Delivery of Laser Inertial Fusion Energy’, Journal of Fusion Science and Technology, 60, p19 (2011).
[6] Latkowski J. F. et al, FUSION SCIENCE AND TECHNOLOGY 60, 54 (2011).
[7] G. Lehmann and K. H. Spatschek: “Transient Plasma Photonic Crystals for High-Power Lasers”, Phys. Rev. Lett. 116, 225002 (2016).
[8] P. Michel, L. Divol, D. Turnbull, and J. D. Moody: “Dynamic Control of the Polarization of Intense Laser Beams via Optical Wave Mixing in Plasmas”, Phys. Rev. Lett. 113, 205001 (2014).
[9] D. Turnbull, P. Michel, T. Chapman, E. Tubman, B. B. Pollock, C. Y. Chen, C. Goyon, J. S. Ross, L. Divol, N. Woolsey, and J. D. Moody: “High Power Dynamic Polarization Control Using Plasma Photonics”, Phys. Rev. Lett. 116, 205001 (2016).
[10] D. Turnbull, C. Goyon, G. E. Kemp, B. B. Pollock, D. Mariscal, L. Divol, J. S. Ross, S. Patankar, J. D. Moody, and P. Michel: “Refractive Index Seen by a Probe Beam Interacting with a Laser-Plasma System”, Phys. Rev. Lett. 118, 015001 (2017).
[11] M. R. Edwards, V. R. Munirov, A. Singh, N. M. Fasano, E. Kur, N. Lemos, J. M. Mikhailova, J. S. Wurtele, and P. Michel: “Holographic plasma lenses”, Phys. Rev. Lett. February 11;128(6):065003 (2022).
[12] H. Peng, C. Riconda, S. Weber, C. T. Zhou, and S. C. Ruan: “Frequency Conversion of Lasers in a Dynamic Plasma Grating”, Phys. Rev. Applied 15, 054053 (2021).
[13] C. Goyon, M. R. Edwards, T. Chapman, L. Divol, N. Lemos, G. J. Williams, D. A. Mariscal, D. Turnbull, A. M. Hansen, and P. Michel: “Slow and Fast Light in Plasma Using Optical Wave Mixing”, Phys. Rev. Lett. 126, 205001 (2021).
[14] P. Michel, L. Divol, E. A. Williams, S. Weber, C. A. Thomas et al.: “Tuning the Implosion Symmetry of ICF Targets via Controlled Crossed-Beam Energy Transfer”, Phys. Rev. Lett. 102, 025004 (2009).
[15] S. H. Glenzer, B. J. MacGowan, P. Michel, N. B. Meezan, L. J. Suter et al.: “Symmetric Inertial Confinement Fusion Implosions at Ultra-High Laser Energies”, Science 327, 1228 (2010).
[16] P. Michel, S. H. Glenzer, L. Divol, D. K. Bradley, D. Callahan et al.: “Symmetry tuning via controlled crossed-beam energy transfer on the National Ignition Facility”, Phys. Plasmas 17, 056305 (2010).
[17] R. K. Kirkwood, D. P. Turnbull, T. Chapman, S. C. Wilks, M. D. Rosen et al.: “Plasma-based beam combiner for very high fluence and energy”, Nature Physics 14, 80 (2018).
[18] R. K. Kirkwood, S. Wilks, P. Poole, T. Chapman, M. Edwards, N. Fisch, P. Norreys Enabling Ignition Studies and Advanced Power Plants by Development of Ultra High Fluence Beams Produced by Plasma Optics, This Workshop.
[19] Y. Michine and H. Yoneda: “Ultra high damage threshold optics for high power lasers”, Commun. Phys. 3, 24 (2020).
[20] L. Shi, W. Li, Y. Wang, X. Lu, L. Ding and H. Zeng: “Generation of High-Density Electrons Based on Plasma Grating Induced Bragg Diffraction in Air”, Phys. Rev. Lett. 107, 095004 (2011).

1. A plasma based optical system comprising:
a gas source for providing gas to a beam amplification region for producing a plasma;
a seed beam source arranged to direct an input seed beam into the beam amplification region;
at least two beam pump sources arranged to direct pump beams into the beam amplification region for amplifying the input seed beam into an amplified output beam directed at a target, and wherein the at least two beam pump sources are located off-axis of the amplified output beam; and
a radiation shield having a hole and positioned between the beam amplification region and the target so that the amplified output beam is directed through the hole while the at least two beam pump sources are protected from radiation produced by the target due to their off-axis locations.

2. (canceled)

3. (canceled)

4. The plasma based optical system of claim 1, wherein the radiation shield comprises separate spaced apart sections and said hole comprises the space between said spaced apart sections.

5. (canceled)

6. A plasma based optical system comprising:
a gas source for providing gas to a beam steering or amplification region to produce a plasma;
a seed beam source arranged to direct an input seed beam into the beam steering or amplification region; and
at least two beam pump sources arranged to direct pump beams into the beam steering or amplification region to utilize said plasma for redirecting the input seed beam as an output beam directed at a target, and wherein the at least two beam pump sources and the seed beam source are located off-axis of the output beam.

7. The plasma based optical system of claim 6, further comprising:
a radiation shield having a hole and positioned between the beam steering or amplification region and the target so that the output beam is directed through the hole while the at least two beam pump sources and the seed beam source are protected from radiation produced by the target due to their off-axis locations.

8. The plasma based optical system of claim 7, wherein the radiation shield comprises separate spaced apart sections and said hole comprises the space between said spaced apart sections.

9. (canceled)

10. (canceled)

11. (canceled)

12. The plasma based optical system of claim 6, wherein said plasma comprises a plasma grating.

13. The plasma based optical system of claim 6, wherein said plasma comprises a plasma lens.

14. An optical system comprising:
a gas source configured to provide gas to a region for producing a plasma or gas based optic;
at least first and second light sources configured to direct respective light beams into said region; and
an input light source configured to direct an input light beam to the plasma or gas based optic thereby producing an output light beam,
wherein one or more of said first light source, said second light source, said input light source, or any combination thereof are located off-axis of the output light beam.

15. The optical system of claim 14, further comprising:
a radiation shield having an opening positioned between said region and a target so that the output light beam is directed through said opening while the first light source, the second light source, said input light source or any combination thereof are protected from radiation produced by the target due to their off-axis locations.

16. The optical system of claim 15, wherein the radiation shield comprises separate spaced apart sections and said opening comprises the space between said spaced apart sections.

17. The optical system of claim 14, wherein the input light source comprises a laser or laser source.

18. The optical system of claim 14, wherein the first and second light sources comprise laser or laser sources.

19. The optical system of claim 14, wherein said plasma or gas based optic comprises a grating.

20. The optical system of claim 14, wherein said plasma or gas based optic comprises a lens.

21. The optical system of claim 14, wherein plasma or gas based optic comprise a plasma optic.

22. The optical system of claim 14, wherein plasma or gas based optic comprise a gas optic.

23. The optical system of claim 14, wherein said first light source and said second light source are located off-axis of the output light beam.

24. The optical system of claim 14, wherein said input light source is located off-axis of the output light beam.

25. The optical system of claim 14, wherein said output light beam is directed at a target that produces harmful emission.

26. The optical system of claim 14, wherein said at least first and second light sources are configured to direct respective light beams into said region to produce said plasma or gas based optic.

27. (canceled)

28. (canceled)
